(19) United States
(12) Patent Application Publication
(10) Pub. No.: US 2011/0082598 A1
(43) Pub. Date: Apr. 7, 2011

(54) Electrical Power Time Shifting

(76) Inventors: Tod Boretto, San Diego, CA (US); Chris Rodewald, San Diego, CA (US); Robert Park, San Diego, CA (US)

(21) Appl. No.: 12/897,600

(22) Filed: Oct. 4, 2010

Related U.S. Application Data
(60) Provisional application No. 61/248,356, filed on Oct. 2, 2009.

(51) Int. Cl. G06F 1/32; G06F 1/28

(52) U.S. Cl. 700/291; 700/297

(57) ABSTRACT

An energy management system and method can include functions such as monitoring a status of the electrical energy storage device; receiving a first demand from a first power load for electrical power, and determining whether to supply the electrical power to satisfy the first demand from the electrical energy storage device or from one or more power sources connected to the energy management system. The determining can include applying an algorithm to determine a power provision arrangement based on at least one preset criteria. The algorithm can have data input that includes the status of the electrical energy storage device, one or more load characteristics of the first power load and any other loads supplied with electrical power from the energy management system, and one or more source characteristics of each of the one or more power sources. Electrical power can be supplied to the first power load in satisfaction of the first demand and in accordance with the determined power provision arrangement.

### CROSS-REFERENCE TO RELATED APPLICATIONS

The current applicant claims priority under 35 U.S.C. §119 to U.S. Provisional Application for Patent No. 61/248,356, which was filed on Oct. 2, 2009 and whose disclosure is incorporated herein in its entirety.

### TECHNICAL FIELD

The subject matter described herein relates to power generation and storage and in particular to adaptive control of power generation and delivery.

### BACKGROUND

Electricity is produced from a variety of different sources that include nuclear power; gas, natural gas, and coal fired power; and renewable sources such as solar, wind, tidal, hydroelectric power, and many others. When possible, man made sources of electricity are typically designed to ramp up power production to match the demand cycle during a typical 24 hour period in which peak daytime demand can exceed the nighttime demand by a factor of ten or more. Adapting and adjusting to this variable demand curve can be extremely challenging for power producers because of the difficulty in predicting the demand and the fact that many commonly used power sources cannot be stopped or idled without losing the power or creating large inefficiencies. It is estimated that the value of lost electricity in the United States due to these factors is in a range of approximately $21 billion to $75 billion per year. Natural renewable sources like solar and wind also present challenges because they can be both unpredictable in their output and generally subject to periods of low or even zero output interspersed with periods of high output that may not be commensurate with the energy demand profile of the power production facility. In addition, the production of such natural sources typically does not match the utility grid's highest periods of peak demand and therefore may not adequately address many of the greatest challenges facing a power producer's load management issues.

### SUMMARY

The current subject matter manages power consumption, enables efficiencies from devices, and can optionally shut down or reduce the power consumption of equipment according to one or more power consumption reduction algorithms. Such features can have a direct and beneficial effect on the amount of power required to be supplied to the facility from either utilities or internal power generation methods. In either case, the amount of power required can be reduced to a point where load management can be measured and realized as beneficial to not only the facility itself but to the overall grid to which it is or was tied to. In some implementations, the current subject matter can provide a completely zero emission, self reliant, distributed energy system that is capable of also producing energy for its local regional use and can also be used as a storage facility for utilities to tie into for the benefit of the local grid.

In one aspect, a method includes monitoring a status of the electrical energy storage device, receiving a first demand from a first power load for electrical power, determining whether to supply the electrical power to satisfy the first demand from the electrical energy storage device or from one or more power sources connected to the energy management system, and supplying the electrical power to the first power load in satisfaction of the first demand. The determining includes applying an algorithm to determine a power provision arrangement based on at least one preset criteria. Data inputs to the algorithm include the status of the electrical energy storage device, one or more load characteristics of the first power load and any other loads supplied with electrical power from the energy management system, and one or more source characteristics of each of the one or more power sources. The supplying occurs in accordance with the determined power provision arrangement.

In another interrelated aspect, the above-noted operations can be performed by an energy management system that include a processor and at least one electrical storage device, such as one or more batteries that can be included in a battery management system. The energy management system can include a power bus configured to connect to the power sources and power loads and to the electrical storage device. As discussed in greater detail below,

The electrical energy storage device can, in various implementations, be a battery, a battery storage module, another electricity storage device, or some other device that stores energy that can be readily (for example effectively instantaneously) converted into electricity. Example of other devices that store energy that can be readily converted into electricity can include, but are not limited to, pneumatic energy storage devices (for example compressed air or other working fluids), forward osmosis or concentration gradient-based devices, hydro-potential devices, electromechanical devices such as a flywheel or the like, mass potential devices and comparable devices based on potential energy, endothermic or exothermic reaction-based devices, thermal gradient storage devices, phase change-based devices, and the like.

In optional variations, an energy management system can access stored information that includes the one or more load characteristics of the first power load and any other loads supplied with electrical power from the energy management system, and the one or more source characteristics of each of the one or more power sources. A command can be sent to a second power load connected to the energy management system to reduce or stop its electrical energy consumption based on a prediction of power availability calculated using the stored information. The stored information can be accessed from a machine-readable storage medium. The stored information can be collected from the first power load, the other loads, and the one or more power sources and stored on the machine-readable storage medium. The status of the electrical energy storage device can include at least one of a level of available electric power stored in the electrical energy storage device, a temperature of the electrical energy storage device, and a lifecycle parameter of the electrical energy storage device. The supplying of the electrical power can further include passing the electrical power from the one or more power sources through the electrical energy storage device to condition the power.

The one or more power sources can include a first power source having a first current profile and a second power source having a second current profile that differs from the first current profile. The first current profile and the second current profile can be converted to direct current, for example by a power converter. The electrical power can be supplied to the first power load in satisfaction of the first demand with a third current profile suitable for the first power load. The third current profile can be generated by a power inverter, for example.

The one or more source characteristics for each of the one or more power sources can include at least one of a cost per unit of electrical power produced by the power source, a local or global environmental impact per unit of electrical power produced by the power source, a maximum rate of delivery of electrical power produced by the power source, a minimum rate of delivery of electrical power produced by the power source, an optimal rate of delivery of electrical power produced by the power source, and a current operational status of the power source. The one or more load characteristics of the power load can include at least one of a priority of the power load relative to the any other power loads, a voltage for the power load, a current requirement for the power load, and a current operational status of the power load.

Various implementations of the subject matter described herein can provide one or more of the following and/or other advantages. For example, a power consumer (for example a person, business, organization, or the like) can benefit from installation of a system according to the current subject matter within any type of dwelling or business that consumes electricity. The system can improve the efficiency of the power consumer's electricity consumption and can thereby reduce the cost of electricity to that person and allow reinvestment of the saved capital elsewhere. In addition, the reduced consumption can contribute to the overall reduction of carbon emissions through the reduction of energy production. In the case of a power consumer who locally produces as much (or at least nearly s much) electricity as the power consumer consumes, a system according to the current subject matter can be largely if not totally based on use of renewable energy sources, thereby allowing the power consumer to be independent or nearly independent of grid utility power. This reduction and in some cases elimination of carbon producing emissions can allow the power consumer to continue to produce and live while increasing their quality of life and the quality of life of those around them.

In the case of an office or other business setting, the current subject matter can significantly reduce on site carbon emissions by eliminating locally produced carbon and pollutants utilized or formed during energy production. In addition, the system can also facilitate the overall reduction of carbon produced by utilities by removing load requirements during high on-peak periods and then drawing power during times of load shedding by those same utilities. This feature can take advantage of otherwise wasted electrical energy and provide financial incentive to do so. The current subject matter can also permit a facility to dictate the level of reduction in consumption and thus provides benefits in the overall reduction of the necessity to produce power.

The scalability of systems and methods according to the current subject matter can also allow more than one independent system to be tied together and orchestrated in unison for complex facility or campus like energy management. Any size or level of complexity of facility can be accommodated by properly inter-connecting multiple modules or standalone systems.

The system subject matter can also benefit the entire client base of an electrical utility supplier's service area. Systems and methods described herein can flatten out the demand curve of an electrical utility supplier's client base by providing a more consistent temporal load requirement which can be more easily met without the inefficiencies inherent in the ramp-up/ramp-down approach required with currently available electrical power distribution and usage technologies. Consumption needs can be reduced and/or minimized so that excess and waste power is conserved. Using the current subject matter, an electrical utility supplier can size and contract appropriate and accurate resources based on real consumption as opposed to contrived and estimated consumption, for example based on peak loads that occur during only a short time of the day. This in turn can improve the overall efficiency of the utility system and can reduce operational costs and inefficient usage of resources.

Additionally, in areas where power fluctuation occurs at regular intervals due to climatic and regional factors, the current subject matter can be used to bridge discontinuities in the availability of power from external or internal sources. This feature can be important both for quality of life for the environment and for people living and working in these regions but also the commerce of the area as a whole. Constant and reliable power allows for uninterrupted production and productivity. This in turn allows for greater efficiencies across the community as a whole.

The details of one or more variations of the subject matter described herein are set forth in the accompanying drawings and the description below. Other features and advantages of the subject matter described herein will be apparent from the description and drawings, and from the claims. Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of a system for time-shifting electrical power inputs and demands for a facility;

FIG. 2 is a diagram illustrating another example of a system for time-shifting electrical power inputs and demands for a facility;

FIG. 3 is a diagram illustrating features of a battery management system;

FIG. 4 is a diagram illustrating feature of a renewable energy module;

FIG. 5 is a flow chart showing features of a method consistent with the current subject matter; and

FIG. 6 is a flow chart showing features of another method consistent with the current subject matter.

When practical, similar reference numbers denote similar structures, features, or elements.

### DETAILED DESCRIPTION

One way to improve the efficiency of electric power production is to flatten the demand curve where power can be produced efficiently at a constant rate. However, this is quite difficult within current utility systems because a majority of people sleep at night and therefore use less energy. Additionally, many factories produce more and therefore more intensively use energy during the day. Air conditioning electrical loads are also typically highest during the daytime. Since flattening of demand is not a viable option, storing of excess energy would be the next logical direction. Historically, energy producers have utilized large mechanical flywheels to store energy, but such systems are generally fraught with problems. Shedding of excess energy supply to large water pumping stations that consume large amounts of power by pumping the water supplied to a large city like Los Angeles has also been used. Electricity can be recovered from the pumped water through hydroelectric generation. Large lead acid battery storage devices have also been utilized despite the potential environmental threat they can pose and the limited amount of energy that they can store.

Another challenge with electricity and the way in which the grid system is designed in the United States is that energy is typically produced at large production facilities and in many cases is sent through large power lines for distribution. The further the electricity has to travel from the generation source to the demand, the less efficient the process generally is due to resistive losses in the transmission lines. A preferred solution would be to have distributed energy sources that are as close as possible to the demand point. Up until now, this has not been feasible or practical for a variety of reasons.

The current subject matter can provide a high-energy electrical energy storage device that can significantly reduce the cost of electric power and capture a large amount of the electric power that is otherwise lost during periods when power supply outstrips current demand and power would therefore otherwise be lost. Throughout this disclosure, references to electrical power or energy storage, either via a battery or some other electrical power or energy storage system or method, refer to electrical power or energy storage method and systems. The particular storage method or systems used in a given power shifting system is not limited to a traditional battery. The term “battery” is used in the foregoing description for simplicity and clarity of the disclosure, but should be understood to refer to any technology capable of storing and discharging electrical power or energy including, but not limited to, lithium ion iron phosphate, lithium ion iron tetentrate, lithium ion polymer, nickel metal hydride, lead acid gel, lead acid, nickel cadmium, sodium, lithium cobalt, carbon nano, lithium ion based, and lithium ion/carbon-nano technology batteries as well as super capacitors, fuel cells, and various other storage technologies that are or might become available. Lithium ion battery chemistry provides various advantages including, but not limited to, environmental safety and ease of recycling. Various different derivatives of the baseline lithium ion chemistry are all compatible with the current subject matter.

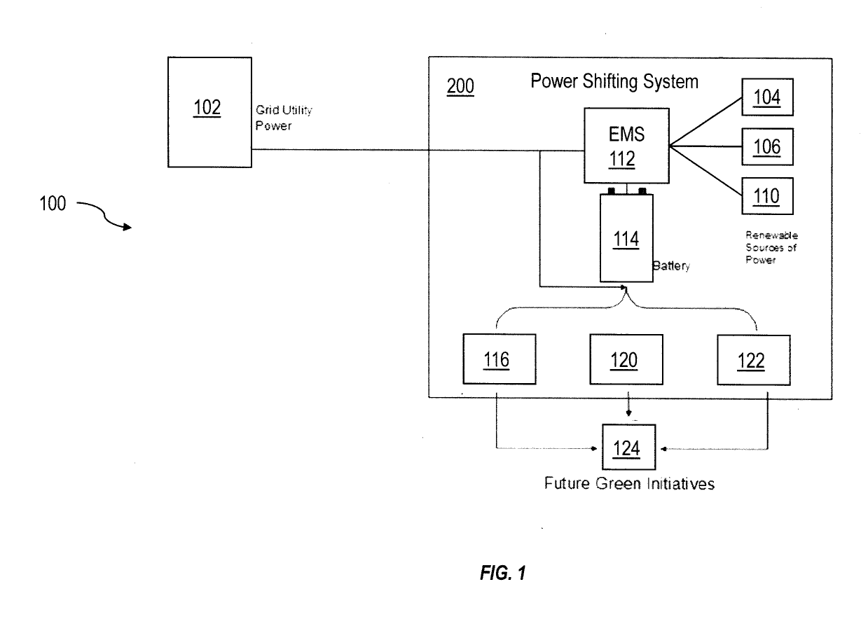

FIG. 1 shows a diagram 100 illustrating operation of an implementation of the current subject matter. Power provided from a utility power source 102, for example over a utility grid, as well as from one or more sources of renewable power, such as for example methane 104, wind 106, and solar 110, is managed by an energy management system (EMS) 112. The EMS 112 controls the storing and discharging of electrical power from a battery 114 or other electrical storage device and can be based upon a modular system approach that utilizes a central control unit (CCU) which contains a charger, inverter, one or more batteries, power management software and hardware, switching gear, and the like. The size of the battery 114 or other electrical storage device can be tailored to the expected power demands on the system. In some implementations, a system can be sized to handle electrical energy requirements in a range of approximately 0.5 kilowatt hours up to 20 or more megawatt hours. In the example shown in FIG. 1, an EMS 112 and its battery 114 can be connected in parallel with power supplied from the grid utility power source 102 that is supplied to one or more homes 116, businesses 120, factories or other industrial facilities 122, and the like. One or more renewable sources 104, 106, 110 can be connected to the EMS 112 to provide parallel energy inputs for use in charging the battery 114. The EMS 112 can be designed to interconnect a series of batteries 114 of other modular energy storage devices so that as demand increases, the system 100 can be expanded quickly and at a low cost. In the case of an industrial factory, the EMS 112 can be hooked up to just the high energy-requirement motors within the factory that consume the majority of the power and are thus most likely to contribute to peak load interval spikes that can be extremely costly. Additional energy draws associated with green energy initiatives 124, such as for example power for charging one or more electric vehicles, can be provided via circuits installed in a home 116, business 120, factory 122, or the like.

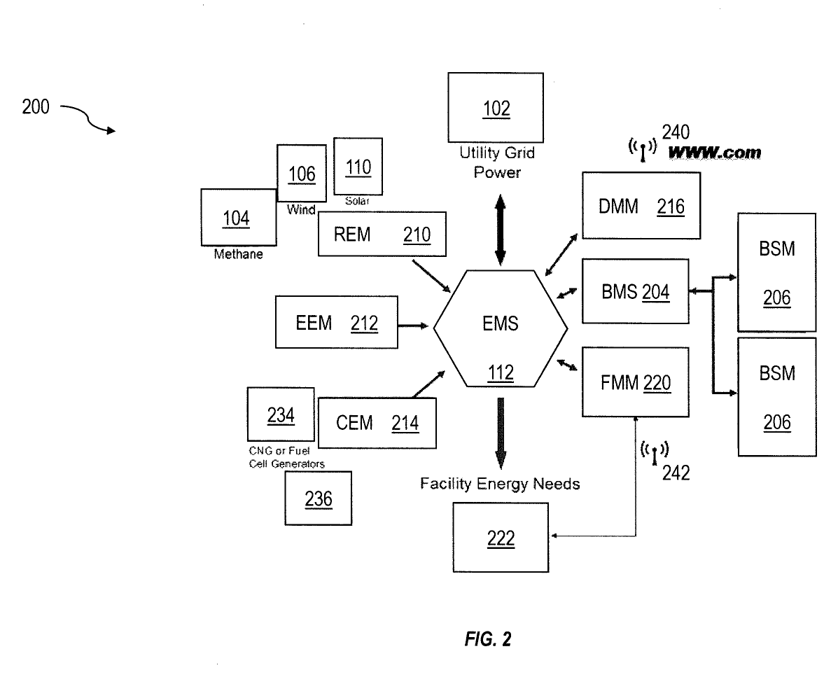

The components of a power shifting system 200 according to a related implementation of the current subject matter can be modular and scalable as shown in FIG. 2. As shown in FIG. 2, one or more modules can connect to the EMS 112. These modules and their connections enable the entire system to be rapidly installed, upgraded and replaced by skilled and unskilled technicians. Modules that can be connected to and controlled by the EMS 112 include but are not limited to a battery management system (BMS) 204 connected to and controlling one or more battery or storage modules (BSM) 206, one or more renewable energy modules (REM) 210, one or more emergent energy modules (EEM) 212, one or more clean energy modules (CEM) 214, a data management module (DMM) 216, and a facility management module (FMM) 220. The power shifting system 200 can be used to supply and manage the energy needs of a facility 222 and can also receive power from the electric utility grid 102. Renewable energy modules (REMs) 210 can include, but are not limited to methane 104, wind 106, solar 110, and the like. Clean energy modules (CEMs) 214 can control and receive power inputs from sources including, but not limited to, clean natural gas electric power generators 234 and fuel cell electric power generators 236. Power input sources from a renewable source can be recognized by the ESM 112 and these input charging sources can be prioritized to be used first in providing charging to the one or more BSMs 206 controlled by the BMS 204. Other sources of generation, including but not limited to natural gas generators, can also be incorporated. These additional sources of power generation can be used to supplement the energy requirements of the facility 222 to facilitate maintaining a desired minimum/maximum draw from the grid 102 in order to achieve the optimal use profile for the facility 222. If the system 200 does not detect sufficient input power from the renewable source(s) 104, 106, 110, etc., or any of the other sources of back up generation to supplement load requirements at a ideal use profile, the system 200 can automatically pull power in from the grid 102 to meet the energy requirements of the facility 222.

The EMS 112 can act as the brain and main controller of the power shifting system 200 and can manage the various inputs and outputs of the system 200 to provide power to a facility 222. The EMS 112 can be the central module to which other modules of the power shifting system 200 connect and through which these other modules provide data feedback. The EMS 112 can be a central collection and access point for service personnel to interact with and retrieve manual data. An administrative interface can allow manual changes to the parameters of the system as dictated by the administrator or owner of the system 200. One or more web interface devices 240; radio transmitters 242; and/or ports (not shown in FIG. 2) for computer related connections for diagnostics capabilities, overall system management, and upgrading firmware and other hardware switches both at the unit and remotely can be included as well.

Systems and methods according to some implementations of the current subject matter can charge or otherwise store electrical power or energy during periods of non-peak demand when electricity rates are lower and when a substantial fraction of generated electricity is lost because of insufficient storage capabilities of energy producers. Once the device or system is charged, power can then be discharged during periods of higher demand for electric power. Furthermore, the current subject matter can provide functions that allow user control of the rate at which the storage system is charged as well as the time period during which the charging occurs. Most utility billing is based not only on the amount of energy consumed, but also on the peak demand of any 15 minute interval during a billing cycle or other time period. Additional fees can be computed based on peak usage are frequently. These additional fees are sometimes referred to as non-coincident demand and can make up a significant portion of a customer's utility bill. The current subject matter facilitates significant reductions and “flattening out” of peak demand periods by customizing and metering the amount of energy pulled from the gird during any given interval.

Systems and methods consistent with the current subject matter can include built-in safety features to align with the requirements of utilities to manage the utility's grid and transmission lines. These safety features can ensure that there is no back feed of energy from the installed system behind the meter back onto the grid. This sub system of detection, analysis, and cut off switching can provide an integral gateway to ensuring safety of the installed system as well as the immediate feed-in lines to the facility. This sub system can be used independently with just renewable generation equipment for purposes of feeding storage systems or in conjunction with the overall system in a micro-grid configuration.

The current subject matter can also provide emergency backup power systems that can reduce or eliminate the need for gas fired or diesel backup generators, which are frequently costly and can be problematic. In some implementations, energy stored according to the current subject matter can be extracted very quickly, for example within about 15 milliseconds, to prevent shutting down of electrical devices in use during the time of a power outage. Systems such as those described herein can also qualify as emergency generator sources of power that, if set up properly and with the appropriate agreements in place, can allow a utility company to pull power from the device in time of high demand to supplement the grid energy requirements. In this case, the owner of such a system can be compensated for the power sent to the grid. System management software as described herein can provide the ability to track and record any power sent back into the grid to ensure proper compensation of a system owner who makes this kind of energy banking contribution.

The current subject matter can also provide control access through a wireless connection, a remote connection over a network such as the Internet, or the like, in addition to manual controls on the actual unit. Control monitoring of the EMS 112, for example including the state of charge of the batteries or storage devices, health metrics of the batteries or storage devices, and the like, can also be performed via such a remote access connection. A “hot swap” of one or more batteries 114 or electrical power storage modules or devices can be enabled so that if one of the modules or devices requires replacement, for example to facilitate routine maintenance or replacement of a faulty component, the entire EMS 112 need not be shut down.

According to various implementations of the current subject matter, an EMS 112 can learn, manage, and manipulate energy sources and consumption requirements for a metered facility. A facility 222 can be any structure or installation that has a meter to monitor its consumption, for example a component of a commercial venture, the entire business or even a residence. All applicable locations of installation can be referred to as a facility 222. An EMS 112 can provide control of the overall system of power or energy management for a facility 222. The EMS 112 can include software and/or hardware that is physically connected to all inputs of available power generation, potentially including grid provided power from one or more utilities. The output of the EMS 112 can be the consumption requirements of a facility 222 associated with the meter with which the EMS 112 is associated.

The EMS 112 operations can learn or receive manual inputs regarding the scheduled needs of the facility 222 in order to best optimize the energy requirements as well as to manage the cost of operations to be as low as possible for that facility 222. During daytime and normal operations of the facility 222, a mode of operation can include drawing energy from stored battery sources 206, renewable energy sources, supplemental generation, and minimal levels of input from the utility grid during semi peak and peak rate periods. In conjunction with the battery power, the EMS 112 can draw from associated renewable energy sources as the primary energy source prior to any grid provided energy. The EMS 112 can automatically connect grid source power in the event that internal resources, including co-generation and renewal energy sources, are not meeting the current electrical demands of the facility. In one example, the EMS 112 can first use grid power to at least partially recharge the battery or other storage device to maintain a buffer of stored electrical power. If further power is then required it will connect full grid access in order to meet the facility electrical requirements.

During hours of non-operation of the facility 222, for example during evenings and early morning, the EMS 112 can draw grid power if co-generation or renewable sources are insufficient to recharge the storage system. The times of recharge can advantageously correspond to off-peak power periods. Renewable energy sources can also continue to charge the storage system as well and can be used as the highest priority power inputs for charging the battery as managed by the EMS 112. In this manner, the overall requirements for power from the grid can be minimized or at least reduced. The draw from the grid can be managed to be as small as possible by functions of the battery management systems (BMS) 204 and the EMS 112. Using appropriate parameters for the BMS, the draw from the grid can be at least approximately constant. This in turn can reduce the overall non-coincident demand levels for the facility.

The renewable component of the system can include available sources of renewable power to provide power during times of operation and non-operation. In both situations, the renewable energy sources can be the primary source of energy to the storage systems and the demands of the facility. The renewable energy sources can be scalable in the construct to the system and can be increased as well as integrated based on the source of renewable power. Natural gas generators, fuel cells, and the like can also be included in this category of sources. These components can act as back up power for time-of-surge operations for load management, cost cutting measures against peak power grid source, and in the management of non-coincident demand baselines.

The BMS 204 can include software and hardware that functions to maximize the charging of any battery chemistry system or storage device. It optimizes the energy being transmitted to the battery or storage module 206 with minimal fractional amounts of loss. The BMS 204 itself can be designed to be modular and scalable with other peer chargers. In one implementation, the design can be maximized for 3 kW per charger and can be ganged with other chargers in series to get further throughput capabilities. Other maximum charging powers can also be used.

The protocols embedded within the software of the BMS 204 can allow the multiple cells of batteries within a battery or storage module 206 to be treated as a single entity or as separate entities depending on configuration of the system and user preferences. This flexibility allows the battery system to be managed and controlled at a very fine level of detail. A secondary effect of this precise control is the ability to hot swap or remove and add battery cells to a battery or storage module 206 while the system 200 is operating.

The BMS 204 can be configured to handle multiple inputs of power from various sources of energy, whether they are renewable, generator or grid provided. The capability to differentiate from the various sources of power enables the system 200 to pick and choose which energy source to use to either charge the batter or storage modules 206 or provide energy to meet the needs of the facility 222 and to what extent. This selectivity of inputs allows the control of power and directly affects the cost of power that is provided to the facility 222.

An EMS 112 can include one or more connection or input ports as well as hardware and/or software translation functions for handling the various inputs and outputs to the EMS 112. In conjunction with the various input capabilities are the multiple output connections. These connections allow the various independent or dependent battery and or other storage systems to be linked together for a more synergistic power source. The independent outputs also allow for managing disparate load requirements and specific output requirements that are sometimes not yet foreseeable at the time of installation.

The BMS 204 can manage the loads of the batteries 206 or battery storage modules (BSM) 206 and their respective cells. In doing so the system can communicate with the environmental and fire protection systems and/or optionally with a BSM controller that in integrated with the BSM 206 to provides information about one or more of the charge state of the BSM 206, a number of charge/discharge cycles experienced by the BSM 206 and/or its cells, other battery or BSM lifecycle parameters, and the like to keep the batteries 206 within their optimal operating range. Use of parameters such as those listed in determining how to apportion generation sources and electrical power loads can have beneficial impacts on battery life and overall efficiency of the system. The maintenance of specific predetermined or learned charge limits for a BSM 206 and communication of these and other BSM parameters to the EMS 112 can facilitate peak and optimal effectiveness for providing power to the facility.

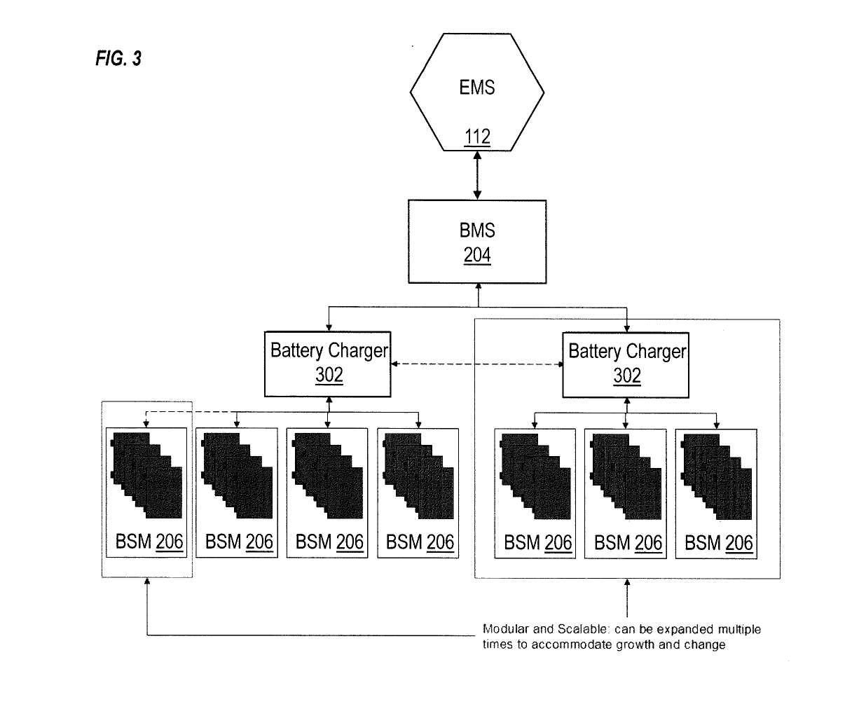

An advantage of a BMS 204 according to some implementations is that the BMS 204 can be functionally agnostic to the power that it manages. FIG. 3 shows additional possible features of such a BMS 204. A shown in FIG. 3, a battery charger 302 or other circuitry, transformers, and the like can be provided to receive power from other sources to the EMS 112 via the BMS 204. The battery charger 302 can be ganged to one or more BSMs or batteries 206. The BMS 204 can be designed to be scalable at installation and can thus handle both low and high voltage situations and can be expanded during its service life by addition of new battery storage modules 206 and battery chargers 302 as needed to meet the needs of a facility or other installation or power demand instance. Different levels of voltage can be accommodated with different qualities of the connectors and other regulated mandates for the specific voltage that is being managed. The scalable and modular characteristics can also enable a power shifting system 100 or 200 to be flexible in its installation as a stand-alone device or connected and ganged with other similar or dissimilar storage devices, chargers and energy management systems.

The battery storage module 206 can allow power to be stored during all hours of the day. The battery or BSM 206 can go beyond the role of a simple storage device by also enabling many other capabilities to the facility through the clean management of the power demands as all sources of power are routed through the battery or BSM 206. The utilization of the battery or BSM 206 can enable the entire system to provide conditioned power and will meet the exact requirements of the facility and its electrical equipment. This in turn allows the overall efficiency of the system to be heightened and summarily reduce the overall load and subsequently the draw from the grid or other power sources.

The current subject matter can be agnostic to the type of battery chemistry used. Current requirements of a given installation can, in some instances, dictate that the battery is capable of high discharge rates and high sustained levels of power output for nearly the entire life of the battery. Advantageously, there should be no significant loss in capabilities over the lifetime of the battery. Recharge capabilities can be provided to allow extremely rapid recharges as well as slow and deliberate slow trickle charges as dictated by the BMS 204 and EMS 112.

Use of battery storage allows a ready source of energy to be used by the facility during hours of operation and non-operation. The battery 206 can also act as a surge protector to the facility during times of power surges from the grid or natural storms. The battery 206 can also act as a universal power supply providing back up power in the event of a power outage, brown out, or black out.

The battery or BSM 206 can optionally be encased for safety in a modular lockable accessible cabinet specifically designed for low and high voltage components. This casing can include metal, plastics or any other acceptable material used to contain electrical components. The size of the case will be dictated by the size and composition of the battery itself. Similarly, a casing for the BMS 204 can be similar to the other modules of the system 200. Its composition can be of metal, plastics or other materials compatible with low and high voltage electric devices. Fire protection can be built into the casing of the battery or BSM 206. The current subject matter can also include one or more of fire detection capabilities as well as signaling to facility alarms, signaling to fire fighting authorities, signaling to monitoring entities, and first response suppression capabilities. A protection system can meet or exceed all safety requirements appropriate to this size and type of encasement. In keeping with a renewable, clean and green theme, the materials can also be made from organic or inorganic recycled materials. The circuit boards and its components can be made from standard commercial off the shelf (COTS) items and/or custom made chips, connectors and boards.

Environmental controls of the battery case can allow specific control of temperature, humidity, airflow, venting, etc. This level of control can include sensors and data management that can be retrieved and analyzed by the BMS 204. The system can be continuously monitored allowing support of an optimal environment providing maximum system efficiencies and product useful life.

Environmental concerns can also be considered in designing the composition and operations of the battery or BSM 206. Although existing lead acid batteries are typically used in similar capacity, their make up and lack of ability to handle large and rapid charges and discharges can be a disadvantage in some applications. Such devices are therefore usable with the current subject matter although other options can be more advantageous. Emergent battery technologies can be utilized as they become commercially available and viable. The flexibility and modularity of the current subject matter can allow the introduction of new batteries or BSMs 206 at any time after the initial installation. Battery storage of a device or system as described herein can be accessed by electric vehicles (EVs) and their recharging portals. The overall system as managed by the EMS 112 and BMS 204 will provide extremely rapid charging of an EV. The storage system is the ideal method of recharge for EVs since the rate of power displacement is not restricted by chargers, lack of voltage or connections. An EV recharging portal can have its power requirements registered with the EMS 112. A power transfer sufficient to fully charge an EV can optionally be performed very quickly, for example on the order of minutes instead of hours based on chemistry and battery to battery transfer rates that function at a much higher rate than charging.

The storage and power management features of implementations of the current subject matter can also be compatible with the needs of the utilities. The battery or BSM 206 can be used, if sufficiently sized, to be a spinning reserve and dampen power brown and black outs for a utility company or region. During times of off peak load, the battery can also be used as a repository to store relatively inexpensive energy as utility level generators shed their loads. Later, that stored energy can be retrieved during times of generation start-up as semi-peak periods emerge. There is also the capability to use the battery or BSM 206 in conjunction with the overall system to be a registered power resource for allocation within a region of the utility.

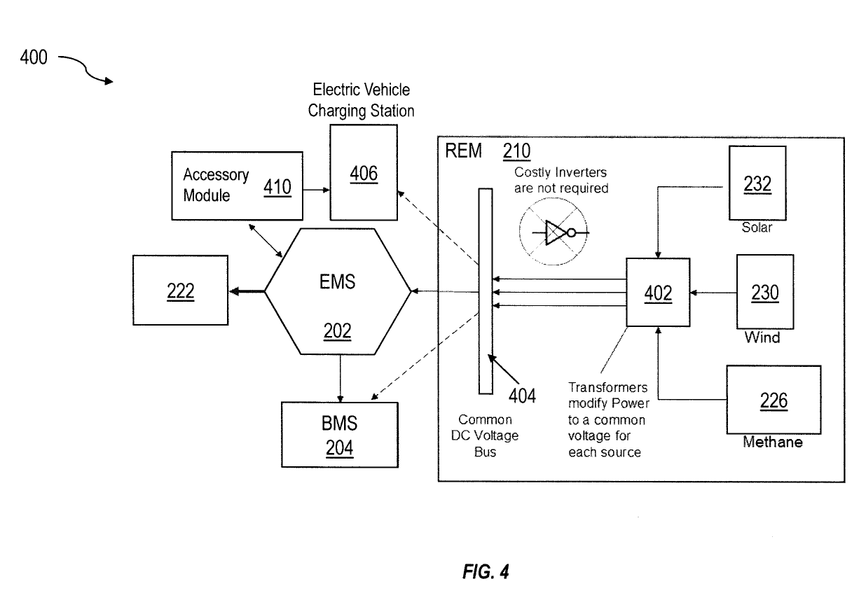

Use of renewable energy sources according to some implementations of the current subject matter can provide substantial advantages over previous approaches in that a number of renewable energy sources can be ganged to provide power through the EMS 112 and to thereby combine the optimal characteristics of each of a number of renewable energy sources to provide power to the overall system. Through ganging of resources there is no dependence to any one source as the driving capability of the system. The collective power generated can be directed to either the load requirements or the battery as the EMS 112 directed through its analysis of the battery or BSM 206 and the needs of the facility. For example, FIG. 4 illustrates additional details about a renewable energy module (REM) 210 according to some implementations of the current subject matter. A REM 210 can include a transformer 402 that modifies power received from one or more renewable energy sources, including but not limited to methane 226, wind 230, solar 232, and the like, to a common voltage. The REM 210 also includes a common voltage DC bus 404 that receives the voltage provided by the transformer 402. The common DC voltage bus 404 can provide electrical energy from the REM directly to the EMS 202 and/or directly to other energy demands of a system 400. These other energy demands can optionally include, but are not limited to, an electric vehicle charging station 406 and a battery or storage module (BSM) 206. An electric vehicle charging station as well as other power loads can also optionally be charged via an accessory module 410 that receives power routed through the EMS 112. An emergent energy module (EEM) 212 can have similar features to a REM 210 depending on the characteristics of the emergent energy sources to which it is connected.

An EMS 112 can be capable of connecting to any new and emergent energy generation methodology and process, including those discussed herein or others that may become available in the future. The REM 210 can advantageously provide as much power to the EMS 112 and to the charging of the BSMs 206 as these sources of power are capable of providing and/or as a user is willing to install or otherwise invest in. In some implementations, an objective of the current subject matter can be to produce more energy than is necessary for the operations of the facility in order to benefit the facility, local region and its people. Renewable energy sources can include but are not limited to solar photovoltaic (PV), solar concentrated photovoltaic (CPV), wind turbines, magnetic induction, piezo-electric, natural gas generation, fuel cell technology, biofuel generators, bio-mass generators, geothermal, thermocouple, co-generation, nuclear, wave motion energy capture, hydroelectric, hydrogen fueled generation, methane generation, and the like. Emerging and existing methods of scavenging energy for purposes of reutilization back into the general pool for consumption can also be employed with the current subject matter as renewable or emergent energy sources.

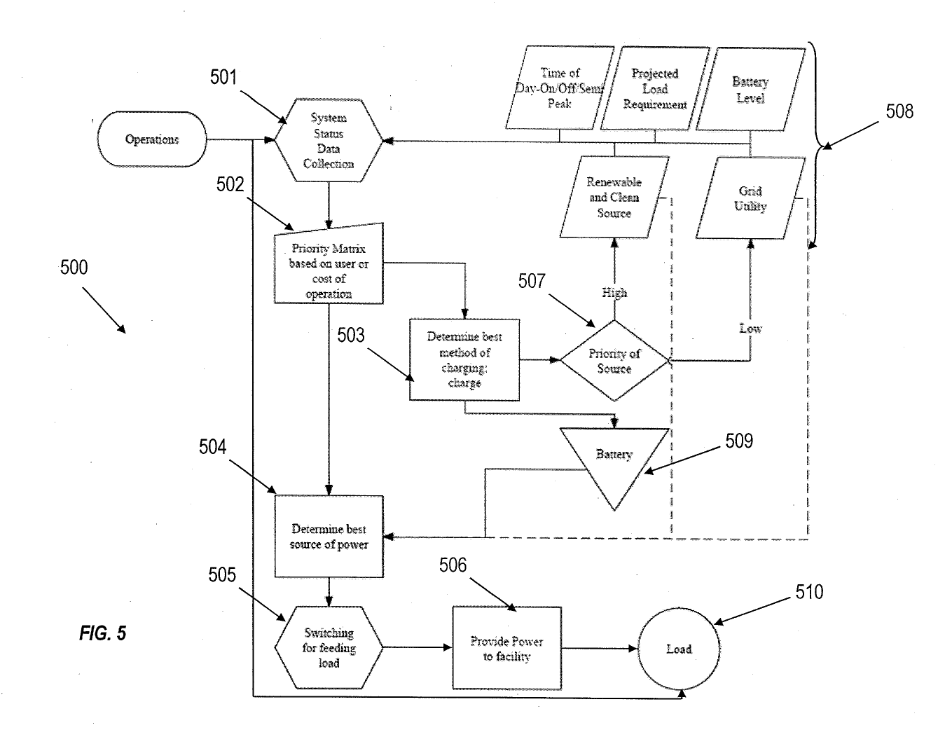

The flow chart 500 of FIG. 5 illustrates features of a method consistent with one or more implementations of the current subject matter. An EMS 112 can manage the load requirements of a facility 222 as follows. Software and/or hardware aspects of the EMS 112 can collect, evaluate, and make decisions to best optimize the load and input requirements of the power shifting system 100 or 200. The operations of a daily cycle can begin with a status of the entire internal grid 501 of the facility. These data can then be compared against known or analyzed data to provide the most effective energy management schema 502. At 503, the most efficient method of maintaining minimal amounts required within the storage system can be determined. A selection based on economical factors can dictate the sources of inputs at 507. These sources of inputs can be allowed to tie in at 508 to the storage 509. Based on several factors, the best source of power can then be routed to the main junction boxes, if not directly to the storage 509, within the facility at 504 and the load would be met 505. The cycle would then start again with knowing the load 510 and then cycling once again to 501.

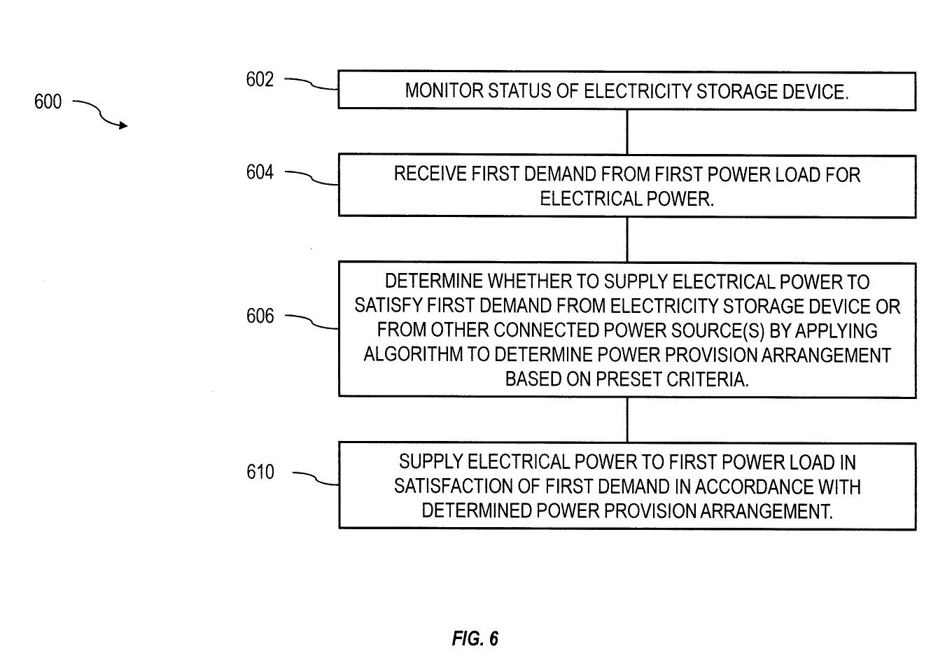

In an implementation illustrated by the process flow chart 600 of FIG. 6, an energy management system 112 that can include at least one processor and at least one electrical energy storage device can, at 602, monitor a status of the electrical energy storage device. At 604, the energy management system 112 can receive a first demand from a first power load for electrical power. At 606, a determination is made whether to supply the electrical power to satisfy the first demand from the electrical energy storage device or from one or more power sources connected to the energy management system. The determining can include applying an algorithm to determine a power provision arrangement based on at least one preset criteria. The algorithm can be based on data inputs that include the status of the electrical energy storage device, one or more load characteristics of the first power load and any other loads supplied with electrical power from the energy management system, and one or more source characteristics of each of the one or more power sources. At 610, electrical power is supplied by the energy management system 112 to the first power load in satisfaction of the first demand and in accordance with the determined power provision arrangement.

Technologies that have yet to be interconnected to provide a viable power source to a facility can also be advantageously integrated according to some implementations of the current subject matter. As an example, regenerative braking, such as is used in electric and hybrid cars can be used with elevators as a method of capturing the freefall energy produced during descents. Such forms of combined technology can serve both to stop the elevator and to generate or recover additional power that can be used elsewhere. Similarly, the potential energy of water that is dumped via drains (most likely gray water) can be recovered through turbines, which can then contribute to the whole efficiency of building energy resources. Tall skyscrapers in which drain water can have substantial potential energy present an additional opportunity for the use of such devices that, because of their intermittent generation capacity, are well suited for use with an EMS 112 according to one or more implementations of the current subject matter.

The current subject matter can provides benefits with regards to storing energy as well as balancing it. Another technology that could be interconnected are piezo-electric power generation devices used in large heavily trafficked areas to generate power via the motion of persons or vehicles passing over the micro generators.

Scavenging techniques including, but not limited to, energy recapture from exhaust systems of heating, ventilation, and air conditioning (HVAC) systems or other high volume equipment sets can also be used. Similar methodology can be utilized in any existing system that moves fluids or gases under pressure. By being able to integrate emergent and established technologies, a system according to implementations of the current subject matter can increase efficiency by offsetting the different power generation profiles of the different technologies to provide clean, consistent power to served electrical loads.

In a further implementation, the impact of a set or sets of electrical power loads within a facility, residence, or other fixed or mobile power consumption location can be eliminated or substantially reduced from using grid power. For example, in a residential home with a swimming pool, the cost of running the pool pumps can be the single largest point consumer of electric power. An accessory module 310 or sub-system can isolate the pool pump, convert it to DC and supply the pump preferentially or even exclusively from renewable sources of power. As an additional capability, the solar panels can be installed to act as a shade to the motors and further allow them to run more effectively. This overall subsystem can in a sense create a “nano-grid” that can be self sufficient and thereby eliminate a major cost in any residence or facility involving pools. If appropriately sized, such renewable energy generation capacity can be coupled to the EMS 112 to contribute a further source of power as well as an asset that can be more easily managed. In addition to the pool pump system, other passive ways to save and reduce loads in a more economical method can include heating a pool via solar heating but without the necessity to put up black collection grids on roofs for heating. In this example, PEX© tubing used in under floor radiant heating systems in homes can be laid into the concrete surrounding the pool and making up the pool deck. Such a system can act as a conduit to transfer stored heat in a thermal mass (deck) to the pool. In this case, by reacting to sensor data giving the temperature of the deck, solar incidence, time of day and temperature of the pool water the EMS 112 can forecast and manage the delivery of electrical energy to an electrical pool heater to keep the pool temperature constant. Such a system can also reduce the cost of operation due to the fact that a lesser sized motor can be used since the water is not being lifted to great heights and is simply moved around at ground level; coincident with the pump. Such incremental, active and passive methods combine well to reduce energy demand and enable self reliance when dealing electrical loads and renewable sources.

A facility management system according to one or more implementations of the current subject matter can include many elements of the smart grid initiative. For example, the EMS 112 can control many facets of the energy consumption within the facility. The software algorithms executed within the EMS 112 can be capable of learning the use patterns, power requirements, and/or other characteristics of individual rooms, equipment, devices, and other electrical power loads supplied with power via the BMS 204. In turn, the system can be allowed to power on and off those aspects of the facility when they are no longer required to be on or in accordance with a hierarchy or other ranking of criticality of a given load and/or ability of the load to be reduced, shut-off, or shifted in time to a period when other loads on the system are smaller. In this manner, the load requirements of the overall systems and the draw from the sources of energy can be further reduced.

Such a system can be fully or partially customizable and can optionally manage electrical equipment at the facility through distinct tracking information unique to each specific piece of equipment or power load that is controlled. Individual pieces of equipment, whole rooms, subsections of circuit breaker panels, and the like can be controlled. Management of data for these devices can be provided either locally or remotely by a connection such as WiFi, Internet, radio transmissions, transmissions through physical power lines or over telephone circuits, and the like. Current COTS technologies can also provide communications conduits. Each device, power load or group of power loads, unique circuit, or the like can have the capability to transmit data of each aspect of operation for that particular element. Unique signatures can enable the management system to shut down, power up or monitor consumption in a very detailed manner. This capability can also be applied to legacy type devices that are not fitted with smart grid technologies within their circuitry, for example by using a custom fitted pre-plug into which the device plugs and which can be connected to existing power outlets.

A power management system can have many different types of overrides to compensate for unexpected behavior for an area being managed. For example, in the event that personnel need to continue to work beyond normal operational times, sensors can sense a presence and need to keep devices on. Such sensors can then override a scheduled shut down and continue to monitor the area until a predetermined time of non-activity occurs. Subsequently, the system can continue its management procedures through selective power shutdowns determined by the facility and managed through one or more program functions of the EMS 112.

An additional advantage of this type of management is that it allows detailed refinements of power consumption control without requiring inconvenience or other concessions by the workforce within the facility. Such a system can aid in the efficiency of the workforce through precision warm ups of equipment and devices. Such features can be applied to operations as simplistic as a coffee maker or copy machine as well as to more complex functions such as a HVAC system within a building. For example, once a latency period has expired where no person has been detected within a space, the HVAC and all non-essential operations can be turned off. Conversely, prior to the start of the next work day, those very same systems can be warmed up and turned on within sufficient time prior to the arrival of any person softening the load requirements.

Current “smart grid” initiatives, not to be confused with the utility based national grid upgrades, can also be assimilated and integrated with the current subject matter due to the flexibility and modularity of systems and methods described herein. Advancement within consumer products can make the overall facility even more efficient and power thrifty.

The ability to facilitate integration of the many disparate systems can provide another advantage of the current subject matter. By harnessing the beneficial capabilities of each individual technology and then combining them in a synergistic manner under a common standard, the overall system can provide power to a facility at a fraction of the current costs regardless of the utility or other power source that is providing power. The integration, scalable, and modular characteristics allow systems and methods according to implementations of the current subject matter to be installed in virtually any size facility or residence.

Any and all sources of energy generation can be integrated into the ready pool of power to be used in the facility. Implementations of the current subject matter can include systems capable of handling both AC and DC current. Integration of a variety of energy sources can involve addressing the standard current and voltages under which the power is integrated. New and existing renewable sources can be easily manipulated to work with the current subject matter. Emerging clean or renewable sources can also be integrated using straightforward conversion to the system standards according to an implementation.

Integration of the various subsystems, resources, and accessories can provide a management capability that is aware of and optionally in control over all or at least a subset of aspects of the electrical demands of a facility. Those aspects that are connected can be maximized in terms of efficiency as well requirements to be powered. This provides a very refined method of managing consumption. Management can be able to appropriately power up and down specific devices as well completely shut them off. Under such conditions, “vampire type” load losses can be minimized as can inefficient consumption based on improperly matching device requirements to power available. This entire methodology can directly result in the conservation of power and the load capacity of the overall grid network outside of the facility. Immediate impacts to the cost of operation can be immediately realized upon installation of a system or method according to implementations consistent with the current subject matter.

The modularity of the design of various implementations of the current subject matter can advantageously accommodate additions or removals of power loads and sources from a facility. This ability can apply to sources of power, load management protocols, software updates, accessories, battery or storage methods and devices, and the like. The flexibility can be built in to have the modules retain a chaining or ganging approach to their subsystems. This feature can allow for additional growth as well as expansion of any subset of the module. The module in turn can feed into the EMS 112. Since each EMS 112 has the capability of chaining with another EMS 112, a system with multiple EMS devices installed can provide redundant and parallel capabilities, for example for use as a back-up system or to allow maintenance work on one EMS 112 while others remain operational.

There can be instances in which a renewable energy source is not appropriate or available at the time of the original installation of a system according to implementations of the current subject matter. In this case the system can continue to benefit the facility but the later addition of renewable or clean power can be made available due to the flexible and modular nature of the system and its component modules. The flexibility of the system can be further increased through remote access monitoring and upgrading. Remote access can be made available through a variety of means, including but not limited to phone lines, radio technology, or through common World Wide Web interfaces. Real time corrections and manipulation can allow management, monitoring, or owner/user participation and corrections to the efficiency of the system as a whole or in specific parts. Real time corrections can also enable greater cost effectiveness to be realized as conditions change or are modified.

Integration designed into a system according to the current subject matter can include scalability and modularity that allows for the very refined handling of power demands of a facility. Flexibility at all times to manage the system using human-based or artificial intelligence allows for a facility to optimize its needs and costs. This applies to any size facility that the system is installed in. Systems and methods in accordance with one or more implementations of the current subject matter can be capable of handling the requirements of a singular load task up to the complex multiple load requirements of an entire complex.

In a residential venue, a system according to an implementation of the current subject matter can be installed in a home, dwelling, or other residence. In some implementations, the residence can be connected to an electrical meter metering power delivered from a utility, for example via the electric power grid. However, this is not required for proper operation of the system. By ranking or otherwise considering the desirability of each connected power source based on the characteristics of each connected power source, systems and methods according to implementations of the current subject matter can minimize the overall consumption of the residence while simultaneously optimizing the use of available power sources to achieve one or more preset or user-determined goals (such as, for example, minimizing total power costs, maximizing use of renewable resources, etc.). In many cases, if adequate renewable energy sources or clean energy generation sources are available, a system such as described herein can be fully disconnected from grid reliance.

The current subject matter can also be used in other industries, including but not limited to agriculture. The remote nature of many agricultural facilities and the typically elevated sporadic—both on a daily and seasonal basis—demand for power can be well matched to the management, storage, and independent control of renewable sources of power combination provided by the current subject matter. Use of the current subject matter can allow farmers to automate crop management to include energy cost reduction, load elimination or mitigation, more efficient use of renewable resources, and the like.

Rural or remote locations can also benefit in a similar manner. The scalable nature of systems and methods according to the current subject matter can permit downsizing of components of the modules to be used in smaller demand situations as in the rural marketplace. This does not take away expandability or cost saving or energy reduction measures within the core EMS 112. In this scenario systems can be designed to be fully independent and operable 24 hours a day.

A power module consistent with implementations of the current subject matter can be designed to meet one or more non-traditional (e.g. off grid) electrical requirements simultaneously. Such a system can be designed to meet several electrical requirements simultaneously including, but not limited to, power generation, storage, distribution, and frequency regulation and can effectively function as a hybrid generation system to in some examples create a local power grid. A system can incorporate and prioritize renewable energy sources first and do so without the typical problems associated with the intermittency of these renewable energy sources in off grid environments thanks to the integrated electrical energy storage of the battery or BSM 206. Such a system can, in some examples, be designed to enhance the efficient utilization of electric power generators at forward operating bases (e.g. in a military context) or in other microgrid environments such as in disaster recovery efforts, small island or other isolated settlements, space exploration, and the like and can also augment or in some cases replace portable non-renewable energy sources (e.g. diesel or other fossil fuel fired generators) through integration of locally available renewable and non-renewable sources.

A stand-alone system can be ideally suited to act as a storage bridge for off grid applications when integrated with existing power generation systems. Such a system can be used independently or in combination with other units to provide reliable energy to meet a wide variety of load requirements regardless of the intermittency of the available power sources. Automatic load management can be provided for small grid networks that can often experience large load shifts throughout the course of a 24 hour operational protocol. The system inputs of generator power, renewable power, grid power, or power from any other available source can be transferred to energy storage and then discharged to satisfy load demands from one or more loads. Generated alternating current (AC) power can be converted to direct current (DC) for storage in the battery or BSM 206. DC power from the battery or BSM 206 can be inverted to AC for output to satisfy load demands. In this manner, power conditioning and universal power supply features can also be provided to supply clean, uninterrupted power regardless of the type and quality of available power sources in a local area.

A system according to implementations of the current subject matter can also function as a storage bridge for more traditional power generation sources such as portable, fossil fuel fired generators, thereby allowing them to run more efficiently. One or more generators can be operated at full capacity when electrical power is needed to charge the battery or BSM 206 during times of storage charge. Alternatively or in addition, one or more other available power sources can also be used to recharge the battery or BSM 206. The energy management system 112 can intelligently select among available electrical energy sources to maintain the battery or BSM 206 at a desired charge level while taking into account one or more characteristics of the power sources, such as for example cost, temporal availability (for example, solar generation highly diurnal, and wind and tidal energy can likewise be cyclical), intermittency, environmental impact, and the like to be able to provide necessary electrical energy under preset or operator-specifiable parameters. The EMS 112 can also take into account one or more characteristics of the one or more electrical loads serviced by the system. For example, loads can be ranked by priority such that, if shutting off or time deferring of a load is required to achieve greater efficiency of the system, a lower priority load is shifted as opposed to a higher priority load.

In an example in which portable generators are used to supply power, the one or more generators can be shut down when a charging cycle is completed or when they are otherwise not needed for charging due to available electrical power form one or more other sources. While the one or more generators are shut down, stored energy is provided from the battery or BSM 206 if other sources are insufficient to satisfy current demand. This approach can allow for a significant reduction in hours of operation of the generators (increasing mean time between service), increasing generator efficiencies (for example by avoiding running the generators at partial loads where they are less efficient), and effectively eliminating conditions for wet stacking or passing of unburned fuel to the exhaust system, which can be a common problem diesel generators experience when they are run at less than 50% of capacity. By recharging the battery or BSM 206 at intervals, such a system can be inherently far more efficient than currently available approaches to providing off-grid power. Losses can be limited to those experienced through component inefficiencies while eliminating or at least reducing losses arising from load management design. The system can avoid the need for phase matching between different sources of AC power because the AC inputs are converted to DC storage and then inverted back to AC to supply load demands. Sine wave and distortion can be reduced or minimized—an important consideration for sensitive equipment—by supplying power through an inverter that acts as a conditioner.

A system such as described herein can alternatively or in addition facilitate the use of smaller generators to service larger loads by utilizing the concept of load shifting in which electrical energy produced by the generator is stored during periods of lesser demand for use during periods of higher demand. In this manner, a system need not be designed to handle peak expected loads but rather to handle a maximum energy need integrated over a set period of time (e.g. a day).

One or more inputs of generator power, renewable power, and/or grid power can be transferred to energy storage (e.g. a BSM or battery 206 as discussed above) and then discharged as needed to respond to load demands from one or more electrical power loads. AC or DC power can be converted and stored in a DC BSM or battery 206 and then output directly as DC and/or inverted back to AC power for output. Because of the integrated ability to store generated electrical power, portable electric power generators can be operated at full capacity when the battery or BSM 206 reaches a states at which re-charging is required or if the load demands exceed the capacity of the battery or BSM 206 to supply the necessary electrical power. The portable generators can be shut down at times when charging of the battery or BSM 206 is not necessary. The ability to use generators intermittently but at full generation capacity allows for a significant reduction in hours of operation of the generators (increasing mean time between service), increasing generator efficiencies, and effectively eliminating conditions for wet stacking (a common problem diesel generators experience when they are run at less than 50% of capacity.) Smaller generators can also be used to service larger loads by utilizing the concept of load shifting (charging during times of lesser demand) and energy storage. The unit functions can be broken down to several sections: input source panel and circuitry, storage and storage management, load management and output panel and circuitry.

Systems as described herein can be capable of receiving inputs of all common DC voltages and most standard AC voltages. The input power can then be directed to charge the DC storage as its principle routing. When storage is at full capacity the inputted energy is directed to be cut off (shut down in the case of a generator with auto switching). All the while the load is being met by the storage and the inputted power. The load is met with an efficient source as opposed to a typical generator methodology which provides more power than the load requires and thus can be extremely inefficient. By providing exactly what the load requires, and nothing more, and through recharging at regular intervals only when the system requires electrical power management, the system can be inherently far more efficient than currently available systems and methods. Losses can be limited to those experienced through component inefficiencies while eliminating those that otherwise occur due to poor load management design. The need for phase matching of various power sources can be eliminated by converting AC inputs to DC storage and then inverting back to AC to provide electrical power in satisfaction of load demands. Sine wave and distortion can be minimized as all power provided can be conditioned by passing through the outbound power inverter.

Systems and methods according to this and other implementations can be designed in terms of integrated total energy delivery (i.e. kWh—a similar model to that of an electric power utility providing power through the Power Grid to a home.) Load management can include controlling electrical power usage by the one or more loads drawing from the system to maintain an instantaneous peak KW that does not exceed the max continuous rating of the system installed. Calculations of duration or capacity can be made in terms of power demand integrated over time as opposed to gallons of fuel. The time of energy availability can also be extended whenever consumption is lowered. This extension of resources does not exist in traditional generators since they have marginal capacity to downshift during low load situations and do not have a commensurate reduction in fuel consumption. Generator efficiency can be dramatically reduced at lower load conditions. For example, the effective kWh of electrical energy content per gallon of fuel decreases can decrease by as much or even more than 70% when a generator is operated at partial load. A system or power module consistent with one or more implementations of the current subject matter can avoid losses due to a load increasing or decreasing on any cycle because output of a generator need not be modulated or adjusted in response to changes in load demands. The storage can be managed by a battery management system (BMS) 204 such as is described above.

This BMS 204 in conjunction with a modified commercial inverter can allow unique cycles of inputs and outputs that are not supported in other electrical power systems for mobile applications. The BMS 204 can continuously monitor and maintain the individual cells within a battery or BSM 206 and relative to all electrical energy storage available to the system to maintain the available electrical energy storage in a desired, optimal state of charge, balance, etc. The BMS 204 and other battery monitoring and energy distribution control features of a system according to implementations of the current subject matter storage system can be compatible with a range of battery chemistries and electricity storage technologies such as those described above.

The energy stored in the batteries or BSM 206 can be delivered via one or more inverters to provide continuous single or three phase AC power to service one or more electrical power loads. Spikes in the load can be handled based on a peak power capacity of the system, which can in some implementations be approximately 1.6 times the peak design value for power delivery. For example a system designed for 15 kW peak power delivery can be configured to be capable of delivering approximately 24 kW peak for short periods of time (for example 15-20 minutes). Other configurations are within the scope of the current disclosure.

An inverter system can be tied into the battery or BMS 206 for management and monitoring of the entire system. The inverters can allow AC power to pass through in the event that the batteries or BMS 206 lack sufficient state of charge (SOC) to handle the instantaneous load. The system can communicate with generators that have auto start circuitry or to a system with retrofitted auto start circuitry. The system can also communicate with one or more loads having smart grid circuitry or other software and/or hardware controls that can receive remote commands to turn off, turn on, or increase or decrease consumption.

The system can include inputs for DC power, which can include a variety of sources including, but not limited to, solar, wind, and the like. These DC inputs can be directed to charging the battery or BSM 206 with excess generated power being provided to instantaneous loads. The use of solar or other locally generated or otherwise available electrical power can offset the use of generator or other AC sources during its intermittent time and exist for only a small portion of the day. The DC or AC inputs can also accommodate small and medium scale wind turbines.

A system consistent with one or more implementations of the current subject matter can be managed via a user interface that can be displayed to a user on a monitor that is integral to the system and served by software running on a processor that also implements other functions such as those of the energy management system, battery management system, or the like. Alternatively or in addition, data can be supplied for access (both output and/or input) to an external computing system, such as for example a laptop, personal computer, or mobile computing device (for example a smart phone, personal data assistant, or the like) or over a network connection to a remotely located computing device or devices. Data can be exchanged between the internal processor of a system according to the current subject matter and one or more external computing systems by any wired or wireless means of exchanging data including, but not limited to, a universal serial bus (USB) cable, parallel cable, serial cable, Ethernet cable, phone line, power line, radio or optical link (for example Bluetooth, WiFi, cellular or other wireless wide area link, infrared, or the like), etc.

Voltage output can be configured for nearly all configurations from 240 to 110 VAC with the various phases. The output panel can be customized to meet the needs of direct use or for use with a distribution panel of US MILSPEC or commercial grade.

A system such as described herein can be scalable, modular, rugged, and designed for long term outdoor use, and can provide a complete sustainable solution for civil affairs operations. In the role as a storage bridge between existing portable generation modules and one or more load requirements, such a system can save over 60% in fossil fuel consumption in theaters, such as Operation Iraqi Freedom, Operation Enduring Freedom, and other, future, military operations that include infrastructure restoration or a need to operate in remote regions that are not served by traditional electrical power sources. Such a system can reduce bulk fluid logistical burdens and dramatically reduce the “fully burdened cost” of fossil fuel.

Utility energy producers can also use the current subject matter, for example with integration into resource allocation models to compensate for annual and long range projections of power requirements. By utilizing larger or surplus locations as a ready access storage site, a utility can have nearly instantaneous demand or production surge response capabilities. Unlike fossil fuel generators, which are currently employed for this type of spinning reserve, the current subject matter does not add to carbon loads when employed. Utilities can install such systems independently at or near a commercial venue and use them strictly as storage facilities to enhance the quality of energy produced from the utility company's generation sources or as load management devices during times of surge and peak periods.

The subject matter described herein can be embodied in systems, apparatus, methods, and/or articles depending on the desired configuration. In particular, various implementations of the subject matter described herein can be realized in digital electronic circuitry, integrated circuitry, analog circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input.

The subject matter described herein can be implemented in a computing system that includes a back-end component, such as for example a data server, or that includes a middleware component, such as for example an application server, or that includes a front-end component, such as for example a client computer having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A method comprising:
monitoring, by an energy management system comprising at least one processor and an electrical energy storage device, a status of the electrical energy storage device;
receiving, at the energy management system, a first demand from a first power load for electrical power;
determining, by the energy management system, whether to supply the electrical power to satisfy the first demand from the electrical energy storage device or from one or more power sources connected to the energy management system, the determining comprising applying an algorithm to determine a power provision arrangement based on at least one preset criteria, the algorithm having data input comprising the status of the electrical energy storage device, one or more load characteristics of the first power load and any other loads supplied with electrical power from the energy management system, and one or more source characteristics of each of the one or more power sources; and
supplying the electrical power to the first power load in satisfaction of the first demand, the supplying occurring in accordance with the determined power provision arrangement.

2. A method as in claim 1, further comprising: accessing, by the energy management system from a machine readable storage medium, stored information comprising the one or more load characteristics of the first power load and any other loads supplied with electrical power from the energy management system, and the one or more source characteristics of each of the one or more power sources.

3. A method as in claim 2, further comprising:
collecting the stored information from the first power load, the other loads, and the one or more power sources; and
storing the stored information on the machine readable storage medium.

4. A method as in claim 2, further comprising: sending, by the energy management system, a command to a second power load to reduce or stop its electrical energy consumption based on a prediction of power availability calculated using the stored information.

5. A method as in claim 1, wherein the status of the electrical energy storage device comprises at least one of a level of available electric power stored in the electrical energy storage device, a temperature of the electrical energy storage device, and a lifecycle parameter of the electrical energy storage device.

6. A method as in claim 1, wherein the one or more power sources comprise a first power source having a first current profile and a second power source having a second current profile that differs from the first current profile.

7. A method as in claim 6, further comprising:
converting the first current profile and the second current profile to direct current; and
supplying the electrical power to the first power load in satisfaction of the first demand with a third current profile suitable for the first power load.

8. A method as in claim 1, wherein the one or more source characteristics for each of the one or more power sources comprise at least one of a cost per unit of electrical power produced by the power source, a local or global environmental impact per unit of electrical power produced by the power source, a maximum rate of delivery of electrical power produced by the power source, a minimum rate of delivery of electrical power produced by the power source, an optimal rate of delivery of electrical power produced by the power source, and a current operational status of the power source.

9. A method as in claim 1, wherein the one or more load characteristics of the power load comprises at least one of a priority of the power load relative to the any other power loads, a voltage for the power load, a current requirement for the power load, and a current operational status of the power load.

10. A method as in claim 1, wherein the supplying of the electrical power further comprises passing the electrical power from the one or more power sources through the electrical energy storage device to condition the power.

11. An energy management system comprising:
an electrical energy storage device;
a power bus connected to the electrical energy storage device and configured to receive electrical power from one or more power sources and to deliver the electrical power to one or more power loads; and
at least one processor, the processor performing operations comprising:
monitoring a status of the electrical energy storage device;
receiving, from a first power load of the one or more power loads, a first demand for electrical power; and
determining whether to supply the electrical power to satisfy the first demand from the electrical energy storage device or from the one or more power sources, the determining comprising applying an algorithm to determine a power provision arrangement based on at least one preset criteria, the algorithm having data input comprising the status of the electrical energy storage device, one or more load characteristics of the first power load and any other loads supplied with electrical power from the energy management system, and one or more source characteristics of each of the one or more power sources; and
commanding supply of the electrical power to the first power load via the power bus in satisfaction of the first demand, the supplying occurring in accordance with the determined power provision arrangement.

12. An energy management system as in claim 11, further comprising a machine readable medium accessible by the at least one processor and storing information comprising the one or more load characteristics of the first power load and any other loads supplied with electrical power from the energy management system, and the one or more source characteristics of each of the one or more power sources.

13. An energy management system as in claim 12, wherein the operations further comprise:
collecting the stored information from the first power load, the other loads, and the one or more power sources; and
storing the stored information on the machine readable storage medium.

14. An energy management system as in claim 12, wherein the operations further comprise: sending, by the energy management system, a command to a second power load to reduce or stop its electrical energy consumption based on a prediction of power availability calculated using the stored information.

15. An energy management system as in claim 11, wherein the status of the electrical energy storage device comprises at least one of a level of available electric power stored in the electrical energy storage device, a temperature of the electrical energy storage device, and a lifecycle parameter of the electrical energy storage device.

16. An energy management system as in claim 11, wherein the one or more power sources comprise a first power source having a first current profile and a second power source having a second current profile that differs from the first current profile.

17. An energy management system as in claim 16, wherein the power bus converts the first current profile and the second current profile to direct current and supplies the electrical power to the first power load in satisfaction of the first demand with a third current profile suitable for the first power load.

18. An energy management system as in claim 11, wherein the one or more source characteristics for each of the one or more power sources comprise at least one of a cost per unit of electrical power produced by the power source. a local or global environmental impact per unit of electrical power produced by the power source, a maximum rate of delivery of electrical power produced by the power source, a minimum rate of delivery of electrical power produced by the power source, an optimal rate of delivery of electrical power produced by the power source, and a current operational status of the power source.

19. An energy management system as in claim 11, wherein the one or more load characteristics of the power load comprises at least one of a priority of the power load relative to the any other power loads, a voltage for the power load, a current requirement for the power load, and a current operational status of the power load.

20. An energy management system as in claim 11, wherein the supplying of the electrical power further comprises passing the electrical power form the one or more power sources through the electrical energy storage device to condition the power.
